(19) United States
(12) Patent Application Publication
(10) Pub. No.: US 2009/0055281 A1
(43) Pub. Date: Feb. 26, 2009

(54) Processing systems and methods for vending transactions

(75) Inventors: David M. DeMedio, West Chester, PA (US); Brian S. Krug, West Chester, PA (US); James S. Turner, New Port Ritchey, FL (US)

Correspondence Address: RATNERPRESTIA, P.O. BOX 980, VALLEY FORGE, PA, 19482, US

(73) Assignee: USA Technologies, INC.

(21) Appl. No.: 11/894,104

(22) Filed: Aug. 20, 2007

(51) Int. Cl. G06Q 20/00

(52) U.S. Cl. 705/21

(57) ABSTRACT

Methods for reconciling vending machine transactions occurring between consecutive settlement events and for paying suppliers of vending machine goods are disclosed. Reconciling is accomplished through obtaining a local settlement value at a processing facility representing the total value of all vending transactions that occurred at the vending machine between the consecutive settlement events, receiving an electronic settlement value at the processing facility that represents the vending transactions that occurred at the vending machine between the consecutive settlement events, and reconciling the local settlement value with the electronic settlement value.

### FIELD OF THE INVENTION

The present invention relates to systems and methods for processing vending transactions.

### BACKGROUND OF THE INVENTION

Advances in vending machine equipment and peripheral vending equipment have provided vending operators with greater control over sales, vending machine audits, route management, service scheduling, inventory, cash accountability and product selection.

Processes have been established by owners and operators of vending machines to reconcile sales, inventory and cash collected from the vending machine. The advent of cashless vending has complicated this reconciliation process for owners and/or operators of vending machines due to the creation of receivables and the timing of monies collected. For a vending machine having a cashless device (such as a debit/credit cashless reader), cashless transactions need to be adequately accounted for in order to reconcile sold product with the cash collected from the vending machine.

### SUMMARY OF THE INVENTION

The present invention relates to systems and methods for processing vending transactions. According to one aspect of the invention, a method of reconciling vending machine transactions occurring between consecutive settlement events is provided. The method includes receiving a local settlement value at a processing facility, wherein the local settlement value is the total value of all vending transactions (total cash, total cashless and/or total cash and cashless combined) that occurred at the vending machine between the consecutive settlement events. The method further includes receiving an electronic settlement value from the vending machine, wherein the electronic settlement value is the total value of all vending transactions (total cash, total cashless and total cash and/or cashless combined) that occurred at the vending machine between the consecutive settlement events. The local settlement value is then reconciled with the electronic settlement value.

According to another aspect of the invention, another method of reconciling vending machine transactions occurring between consecutive settlement events is provided. The method includes receiving a local settlement value, generating an electronic settlement value, and comparing the electronic settlement value with the local settlement value.

According to still another aspect of the invention, a method of payment to a supplier of vending machine goods for cashless vending machine transactions occurring between consecutive settlement events is provided. The method includes receiving settlement event indicators for each of the consecutive settlement events and receiving the vending transaction records. The vending transactions occurring between the consecutive settlement events are identified. The vending transactions identified as occurring between the consecutive settlement events are then processed. Once processing of all of the identified vending transactions occurring between consecutive settlement events is complete, payment is remitted to the supplier based on the settlement event.

According to another aspect of the invention, a web-based reporting system is provided to organize and display vending machine sales data for the purposes of monitoring, auditing, reconciliation and settlement operations.

According to still another aspect of the invention, a method of generating an electronic settlement value for vending machine transactions occurring between consecutive settlement events is provided. The method includes the step of receiving settlement event indicators identifying the consecutive settlement events from a vending machine. Vending machine transaction records are received from the vending machine. The vending machine transactions occurring between the consecutive settlement events are identified. The total value of the vending machine transactions that occurred at the vending machine between the consecutive settlement events to generate the electronic settlement value are calculated.

### BRIEF DESCRIPTION OF THE DRAWINGS

The invention is best understood from the following detailed description when read in connection with the accompanying drawings, with like elements having the same reference numerals. Included in the drawings are the following figures:

FIG. 1A is a block diagram depicting an exemplary vending system according to one aspect of the invention;

FIG. 1B is a block diagram depicting the remote processing facilities of FIG. 1A according to one exemplary embodiment of the invention;

FIG. 1C is a block diagram depicting the remote processing facilities of FIG. 1A according to another exemplary embodiment of the invention;

FIG. 2 is a flow chart illustrating an exemplary method of reconciling cashless vending machine transactions occurring between consecutive settlement events according to one aspect of the invention;

FIG. 3 is a flow chart illustrating an exemplary method of generating the local settlement value of FIG. 2 according to one aspect of the invention;

FIG. 4 is a flow chart illustrating an exemplary method of generating the electronic settlement value of FIG. 2 according to one aspect of the invention;

FIG. 5 is a flow chart illustrating another exemplary method of reconciling cashless vending machine transactions occurring between consecutive settlement events according to one aspect of the invention;

FIG. 6 is a flow chart illustrating yet another exemplary method of reconciling cashless vending machine transactions occurring between consecutive settlement events according to one aspect of the invention;

FIG. 7 is a flow chart illustrating an exemplary method of generating the electronic settlement value of FIG. 6 according to one aspect of the invention;

FIG. 8 is a flow chart illustrating an exemplary method of payment to a supplier of vending machine goods for cashless vending machine transactions occurring between consecutive settlement events according to one aspect of the invention;

FIG. 9 is a flow chart illustrating an exemplary method for reconciling settlement period payments according to one aspect of the invention;

FIG. 10 is an exemplary report produced by a web-based reporting system detailing total cash and cashless transactions by settlement period for two vending machines according to one aspect of the invention;

FIG. 11 is another exemplary report produced by the web-based reporting system detailing individual transactions occurring in one vending machine over the course of a settlement period according to one aspect of the invention; and

FIGS. 12A and 12B are simulated screenshots of a exemplary graphical user interface (GUI) illustrating a report of a reporting system detailing total pending and settled transactions for multiple vending machines according to aspects of the invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

As referred to herein, DEX is an acronym for Data Exchange and is the abbreviation for DEX/UCS which stands for Data Exchange Uniform Code Standard. The vending industry has adopted DEX for the electronic retrieval of vending machine data. DEX data includes sales, cash collections, inventory and related information. Data set elements in the DEX standard include the number of bills held in a vending machine bill stacker, quantity and denomination of coins stored in the vending machine coin box, and vending machine inventory, for example. The data set elements are stored in a DEX file. Modern vending management software applications typically use DEX for monitoring, auditing, reconciliation and settlement operations. DEX does not adequately support cashless vending transactions.

The inability of DEX to adequately support cashless vending transactions complicates the reconciliation process for suppliers of vending machine products. In a traditional reconciliation process at settlement, a supplier reconciles the cash collected from the vending machine by an individual (such as a route driver) and the product sold and/or product filled in the vending machine with data stored in the cash transactions recorded in the DEX file. To accurately reconcile collected cash and product sold with the DEX file, the reconciliation process must also account for the cashless vending transactions, the collection of which occurs at a date later than the collection of the cash.

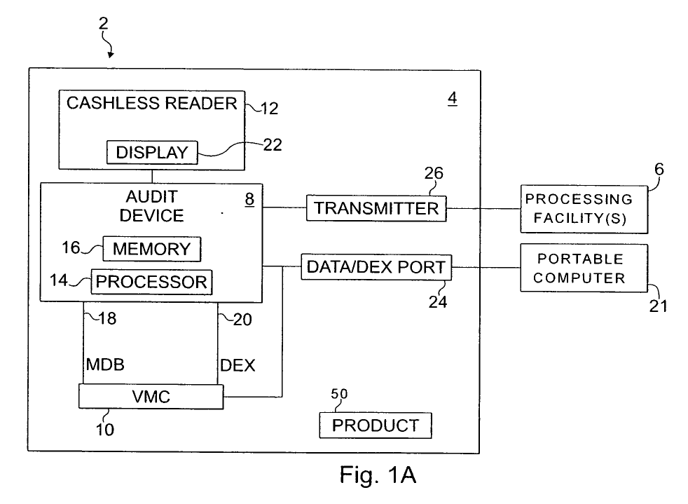

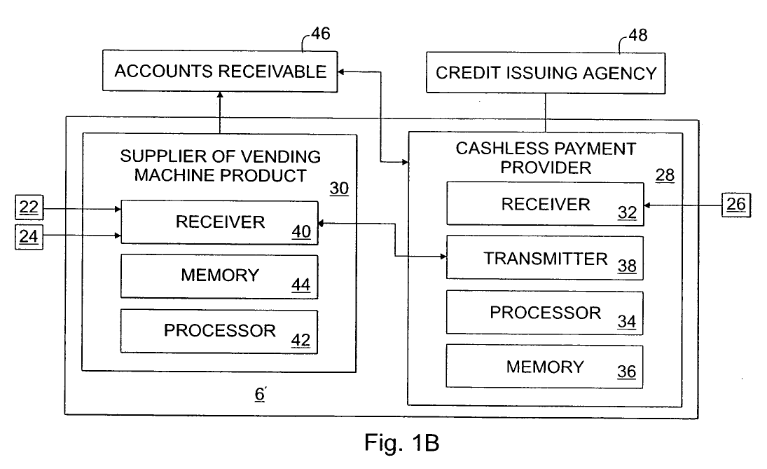

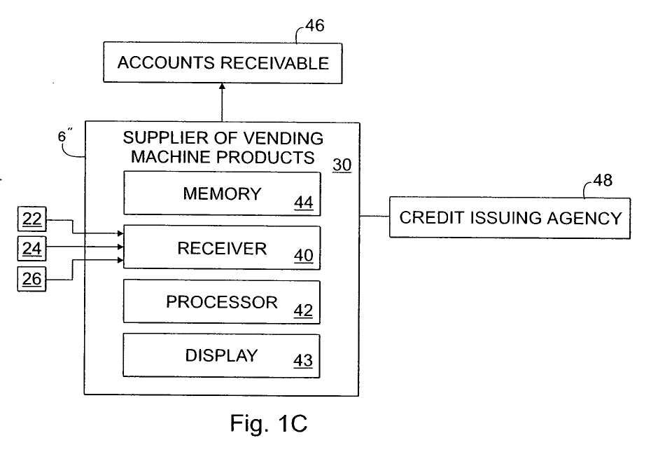

FIG. 1A is a block diagram of an exemplary vending system 2 configured to facilitate reconciliation of cashless and/or cash vending transactions. The vending system 2 includes a vending machine 4 configured to communicate with one or more remote processing facilities 6 for reconciliation of the cashless and/or cash vending transactions. The remote processing facilities 6 may include a cashless payment provider and/or a supplier of vending machine goods and/or an owner or operator of a vending machine, as described in further detail with reference to FIGS. 1B and 1C. An example of a cashless payment provider is USA Technologies, Inc. of Malvern, Pa., USA. Examples of suppliers of vending machine products (referred to hereinafter as a ‘supplier’) is Coca-Cola of Atlanta, Ga., USA, and Pepsi-Cola, of Purchase, N.Y., USA.

The illustrated vending machine 4 includes an audit device 8, a vending machine controller (VMC) 10, and a cashless reader 12. The audit device 8 includes a processor 14 and a memory 16 in communication with the processor 14. In an exemplary embodiment, the audit device 8 communicates with the VMC 10 via a multi-drop bus (MDB) interface 18 and optionally via a DEX interface 20. The audit device 8 also communicates with the cashless reader 12 in a manner that will be understood by one of skill in the art from the description herein. In an exemplary embodiment, the cashless reader 12 may obtain account information from cashless payment devices, such as debit cards, credit cards, RFID (radio frequency identification devices), or other media representative of non-cash payment functionality, and communicate the account information to the audit device 8. The illustrated cashless reader 12 includes an optional display 22 for displaying information.

Among other operations, the audit device 8 may obtain and record cash and/or cashless transaction data from the cashless reader 12 and from the VMC 10, e.g., MDB transaction records via MDB interface 18 and DEX data via DEX interface 20. Data from the cashless reader 12 and/or the VMC 10 may be stored by the audit device 8 in the memory 16, e.g., by the processor 14. Exemplary audit device 8 and cashless reader 12 hardware are incorporated in the sixth generation (G6) Vending Interface Unit available from USA Technologies, Inc. of Malvern, Pa., USA. Suitable vending machines 4, audit devices 8 and cashless readers 12 will be understood by one of skill in the art from the description herein. In an exemplary embodiment, the audit device 8 and the cashless reader 12 are separate components. In an alternative embodiment, the audit device 8 and cashless reader 12 may be integrated into a single unit.

Data may be retrieved from the vending machine 4 via local polling, dial-up polling, or wireless polling, for example. For local polling (also referred to herein as locally recording), a portable computer 21, such as a hand-held computer, laptop computer, or essentially any portable processing device may be connected to a data/DEX port 24 of the vending machine 4 to download the DEX data stored in the VMC 10.

Dial-up polling (via a telephone line, not shown) and wireless polling enables remote access to data, e.g., by the remote processing facilities 6, without a physical presence at the vending machine 4. MDB transaction records, DEX files and/or other data may be transmitted via transmitter 26 (wired and/or wireless) of the vending machine 4 to the remote processing facilities 6 for processing and reconciliation of the cashless and/or cash transactions. The transmitter 26 may be a peripheral device integrated with or connected to the vending machine 4 or the audit device 8. Two embodiments of remote processing facilities 6 are shown in FIGS. 1B and 1C.

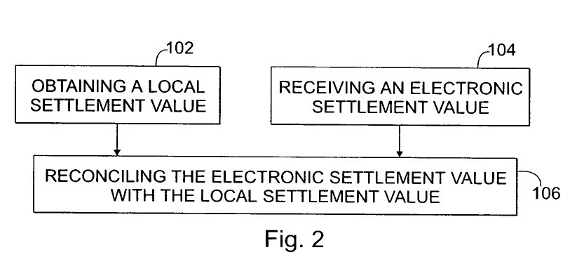

FIG. 1B depicts one embodiment of the remote processing facility 6′. The remote processing facility 6′ includes a cashless payment provider facility 28 (herein cashless payment provider 28) and a supplier facility 30 (herein supplier 30) for reconciliation and processing of cashless and/or cash vending transactions. The remote processing facility 6′ corresponds to the flow charts illustrated in FIGS. 2-5.

In this exemplary embodiment, the cashless payment provider 28 includes a receiver 32, a processor 34, and a memory 36 in communication with the processor 34 for storing the data transmitted from the transmitter 26 of the vending machine 4 (FIG. 1A). The receiver 32 receives MDB transaction records, DEX and/or other data transmitted via transmitter 26 (wired and/or wireless). The cashless payment provider 28 also includes a transmitter 38 for transmitting data to the supplier 30.

The supplier 30 includes a receiver 40 for receiving the data transmitted by the transmitter 38 of the cashless payment provider 28, a processor 42, and a memory 44 in communication with the processor 42 for storing the data transmitted from the cashless payment provider 28. DEX files uploaded from the data/DEX port 24 of the vending machine 4 and data locally recorded from the display 22 of the cashless reader 12 may also be received by the receiver 40 of the supplier 30. In this exemplary embodiment, the supplier 30 reconciles the data transmitted by the cashless payment provider 28 with the DEX files uploaded from the data/DEX port 24 of the vending machine 4 and the data locally recorded from the display 22 of the cashless reader 12, as described in greater detail with reference to FIGS. 2-4.

The supplier 30 may optionally be configured to communicate the data recorded from the display 22 of the cashless reader 12 to an accounts receivable system 46 (identified in phantom lines). The cashless payment provider 28 may also optionally be configured to communicate the MDB transaction records, DEX files, payment transaction detail and/or other data to the accounts receivable system 46 either directly or via receiver 40 of supplier 30 for reconciling data recorded from the display 22, as described in greater detail with reference to FIG. 2. Data from the supplier 30 and the cashless payment provider 28 are posted to the accounts receivable system 46 for accounting purposes. The accounts receivable system 46 may be operated by the supplier 30.

In an exemplary embodiment, data communications between accounts receivable 46 and cashless payment provider 28 is bi-directional. As described above, cashless payment provider 28 is configured to communicate payment records to accounts receivable 46 for reconciling data recorded from the display 22 of the vending machine 4. Data from accounts receivable 46 may then be communicated back to cashless payment provider 28 to report the status of the reconciliation, e.g., no discrepancy or a discrepancy between data recorded from the display 22 of the vending machine 4 and data reported by the cashless payment provider 28.

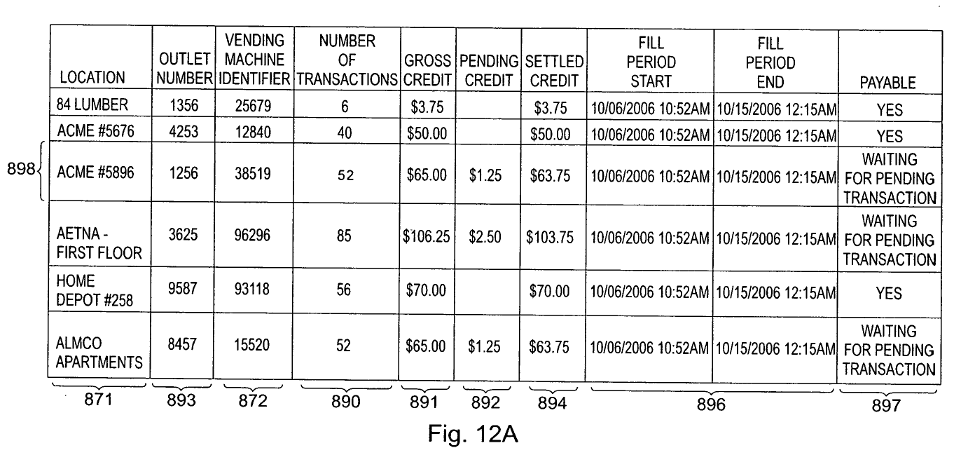

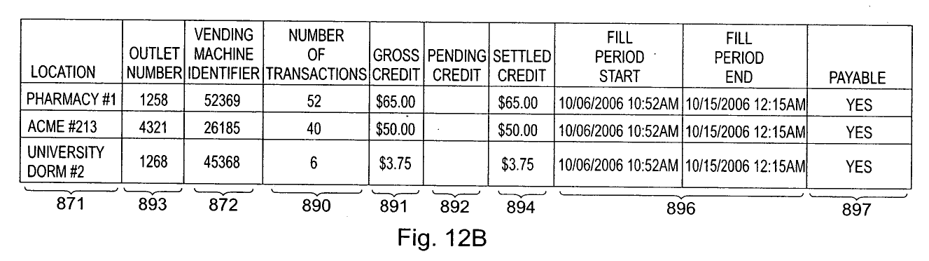

In an exemplary payment remittance scenario using processing facilities 6′, a credit issuing agency 48 (e.g., Visa or MasterCard) remits payment to the cashless payment provider 28 for all processed cashless transactions of the vending machine 4. The cashless payment provider 28 then remits payment to the supplier 30. The details of this remittance process are described in greater detail with reference to FIGS. 12A and 12B.

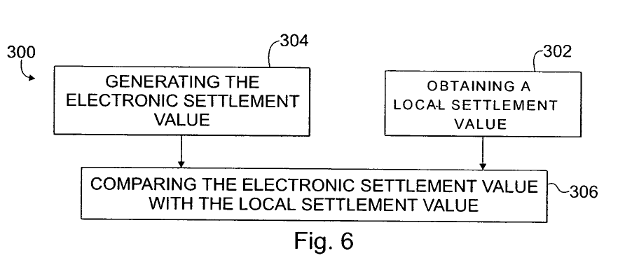

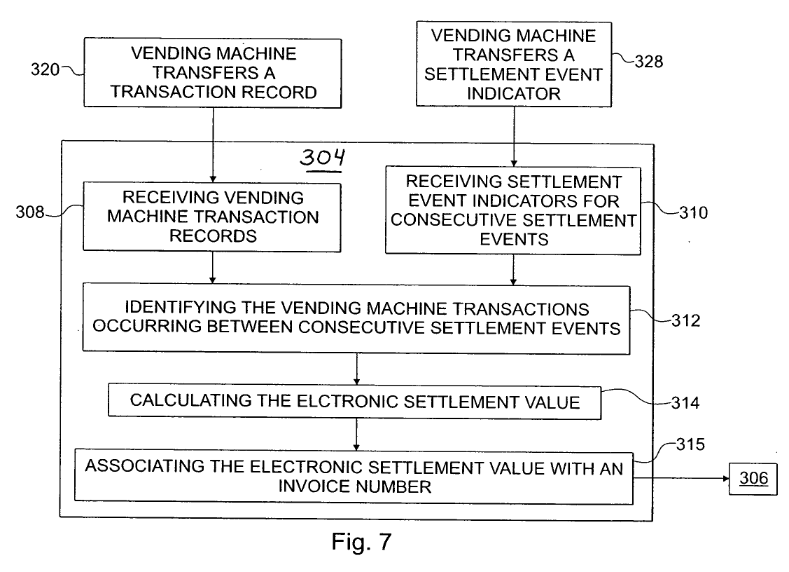

FIG. 1C depicts another embodiment of the remote processing facility 6″. The remote processing facility 6″ includes a supplier 30 for reconciling and processing cashless and/or cash vending transactions. The remote processing facility 6″ corresponds to the flow charts illustrated in FIGS. 6 and 7.

In this exemplary embodiment, the supplier 30 includes a receiver 40 for receiving data transmitted by the transmitter 26 of the vending machine 4 (FIG. 1A), a processor 42, and a memory 44 in communication with the processor 42 for storing the data transmitted from the vending machine 4. The supplier 30 may receive DEX files uploaded from the DEX port 68 of the vending machine 4 and the data recorded from the display 22 of the cashless reader 12 via the receiver 40. The data recorded from the display 22 may be stored in memory 44 at the supplier 30.

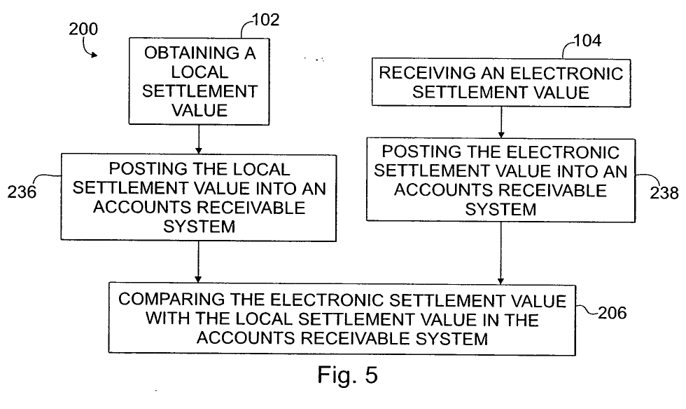

The supplier 30 reconciles the data transmitted by the vending machine 4 with the DEX files uploaded from the DEX port 24 and the data recorded from the display 22 of the cashless reader 12, as described in greater detail with reference to the flow charts shown in FIGS. 5 and 6. As described above, the supplier 30 is also optionally configured to communicate the MDB transaction records and/or DEX files to an accounts receivable system 46 for accounting purposes.

In an exemplary payment remittance scenario using the processing facilities 6″, the credit issuing agency 48 (e.g., Visa or MasterCard) remits payment directly to the supplier 30 for all cashless transactions of the vending machine 4.

The processes described with reference to FIGS. 2-9 facilitate accurate and timely vending machine reconciliation and supplier payment through the utilization of transaction records and remote processing. For ease of description, the processes are described with reference to the hardware depicted in FIGS. 1A, 1B and 1C. Other hardware for implementing these processes will be understood by one of skill in the art from the description herein and are considered within the scope of the present invention.

As used in the following discussion of the inventive processes, a ‘settlement event’ refers to activities associated with settlement of the vending machine 4. Settlement of the vending machine 4 may include one or more of the following activities:
(1) restocking the vending machine 4 with product 50;
(2) adding or removing cash or coin from the vending machine 4;
(3) recording the total value of cash and/or cashless transactions that occurred since the previous settlement event; and
(4) uploading the cash and/or cashless transactions or fields stored in DEX and/or MDB records by the vending machine onto a portable computer 21.
   In addition, the initial implementation of the processes described herein may be considered as a settlement event even though implementation may occur between the above-identified settlement event activities. It will be understood that the settlement event activities may differ from those listed above without departing from the scope of the present invention.

A ‘settlement period’ is the time span measured between a current settlement event and an immediately preceding settlement event. A ‘settlement value’ is the sum total value of all vending machine transactions during a given settlement period. The settlement value may be a separate value for cash transactions, cashless transactions, or other transaction types accepted by a vending machine card reader. The settlement value includes the vending machine transactions that occurred between the current settlement event and its immediately preceding settlement event. Thus, the vending machine transactions that occurred prior to the preceding settlement event may be accounted for in a previous settlement period, and the vending machine transactions that occur after the current settlement event may be accounted for in the next settlement period.

FIG. 2 depicts a flow chart 100 of exemplary steps for reconciling vending machine transactions occurring between consecutive settlement events (i.e., within a settlement period). FIG. 2 corresponds to the block diagrams illustrated in FIGS. 1A and 1B. According to one exemplary embodiment of the invention, the vending machine transactions include all cashless transactions (transactions performed using cashless devices). In alternative exemplary embodiments, the vending machine transactions include all cash and/or cashless transactions that occurred within the settlement period. To facilitate description, the vending machine transactions as described include cashless transactions only. Applicability of the processes to cash and/or cashless transactions will be understood by one of skill in the art from the description herein.

At step 102, the supplier 30 obtains a local settlement value, e.g., via receiver 40 or other receiving device (not shown). The received local settlement value may be stored in memory 44 by processor 42. The local settlement value may be locally recorded at the vending machine, or, alternatively, the local settlement value may be a calculated value that is based upon sales data that was locally recorded at the vending machine.

More specifically and according to one exemplary embodiment, the local settlement value is displayed on the display 22 of the vending machine 4 and locally recorded by the route driver. In another exemplary embodiment, the local settlement value is a calculated figure that is based upon locally recorded sales data, such as the cash collected at a settlement event, the product purchased from the vending machine 4 over the settlement period, or the product added to the vending machine 4 at the settlement event. The supplier 30 may then calculate the locally recorded settlement value based upon that sales data.

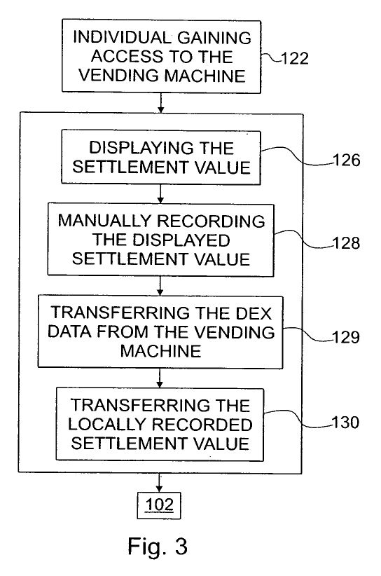

The term ‘locally recorded’ indicates that the local settlement value and/or the sales data comprising the settlement value was manually recorded by an individual (e.g., route driver) at the vending machine during a settlement event. For example, a route driver may manually enter the settlement value and other sales data into a portable computer 21 (e.g., a hand-held device) or record the settlement value and other sales data on a slip of paper (e.g., a voucher or ticket). Additional details regarding generation of the local settlement value are described below with reference to FIG. 3.

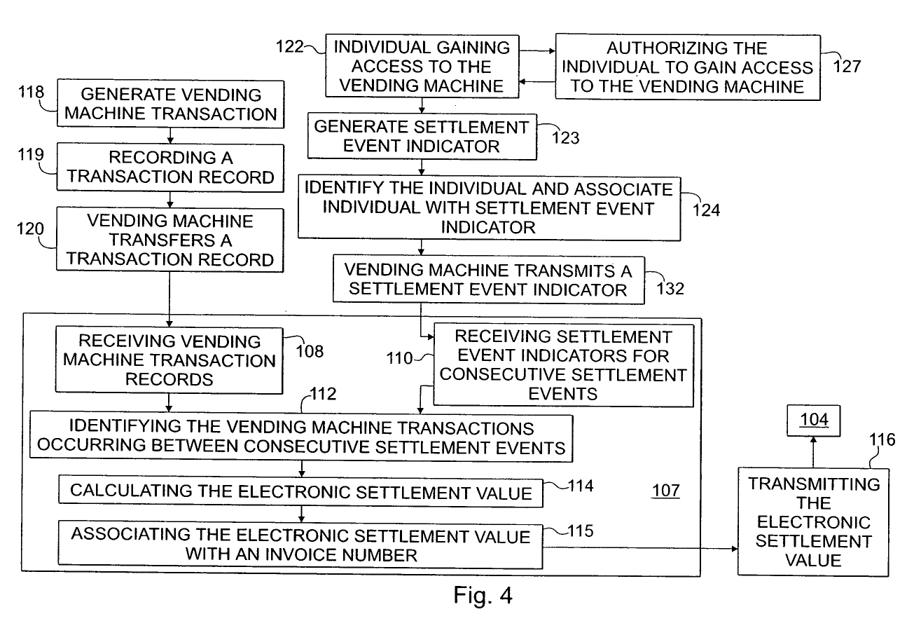

At step 104, the supplier 30 receives an electronic settlement value, e.g., via receiver 40 or other receiving device (not shown). The received electronic settlement value may be stored in memory 44 by processor 42. The term ‘electronic settlement value’ indicates that the settlement value was generated by the cashless payment provider 28 or the vending machine 4 and transferred electronically to the supplier 30 without manual intervention. Alternatively, the transaction records from which the ‘electronic settlement value’ was determined may be transmitted directly to the supplier 30 from the vending machine, and the supplier may calculate the ‘electronic settlement value’ based upon the transaction records. Additional details regarding generation of the electronic settlement value are described in greater detail with reference to FIG. 4.

At step 106, the supplier 30 reconciles the electronic settlement value with the local settlement value. In an exemplary embodiment, the processor 42 compares the electronic settlement value and the local settlement value stored in memory 44, identifies discrepancies between the two values, and presents discrepancies to a user, e.g., via a display device 43 such as a computer monitor or a printer. The reconciliation step 106 ensures accounting for all vending machine transactions and/or settlement values. By reconciling the electronic settlement value with the local settlement value, inaccuracies due to imprecise entries by individuals (e.g., route drivers) can be avoided.

FIG. 3 depicts a flow chart of exemplary steps for generating a local settlement value. At step 122, an individual accesses a vending machine 4 to perform a settlement event. In an exemplary embodiment, the individual unlocks the vending machine 4 and supplies identification information, e.g., by swiping an identification card encoded with identification information through the cashless reader 12, which reads the identification information and passes it to the audit device 8.

At step 126, the settlement value is displayed by the vending machine 4, e.g., on the display 22 of the cashless reader 12. In an exemplary embodiment, the settlement value is displayed in response to the individual swiping the identification card through the cashless reader 12 of the vending machine 4.

At step 128, the individual manually records the displayed settlement value on the debit/credit card display 22 to generate the local settlement value. In other words, the settlement value manually recorded by the individual is the local settlement value. The individual may enter the settlement value directly into a portable computer 21, if so desired. If the individual incorrectly enters the displayed (i.e., actual) settlement value into the portable computer 21, the local settlement value will not be equal to the electronic settlement value.

According to one embodiment, the settlement value stored in the cashless reader 12 resets to zero ($0 and/or 0) approximately one minute after the individual swipes an identification card through the cashless reader 12. The cashless reader 12 is thereafter ready to accept cashless transactions, which are credited toward the next settlement period. The individual may re-display the settlement value up to one hour by re-swiping the identification card through the cashless reader. The individual may press a ‘Cancel’ button (not shown) provided on the cashless reader 12 to manually reset the settlement value back to zero ($0 and/or 0).

At optional step 129 (indicated in phantom lines), the DEX data is transferred from the vending machine to an individual's portable computer 21. The DEX data may be transferred/uploaded to the portable computer 21 through the DEX port 68 of the vending machine 4.

At step 130, the local settlement value is transmitted to the remote processing facility, where it is received by the supplier 30, e.g., via receiver 40 (step 102). In accordance with an exemplary embodiment, the individual transports the portable computer 21 (or paper voucher) to the supplier 30 after the settlement event and transfers (i.e., uploads) the local settlement value recorded at step 128 from the portable computer 21 to the processor 42 at the supplier 30. The processor 42 may store the local settlement value in the memory 44. In an alternative exemplary embodiment, the local settlement value is wirelessly transmitted from the individual's portable computer 21 to the receiver 40 at the supplier 30 while the individual is located at the vending machine 4, or other location remote to the supplier 30, such as cashless payment provider 28. The DEX data recorded at step 129 may optionally be transmitted to the supplier 30 along with the locally recorded settlement value.

FIG. 4 depicts a flow chart of exemplary steps for generating an electronic settlement value. At step 118, at least one vending machine transaction is generated in a known manner. The at least one vending machine transaction is generated in response to at least one purchase completed by a consumer via either cash or cashless means, for example.

At step 119, the transaction records generated at step 118 are recorded, e.g., by audit device 8 in memory 16. For an exemplary cashless transaction, the transaction record is recorded in the memory 16 of the audit device 8 of the vending machine 4 following completion of the cashless transaction and includes data identifying when the cashless transaction occurred (e.g., purchase date). Additionally, the transaction record may include other data fields, such as purchase time, purchase price, vending machine identifier number, vending machine location (e.g., University Dormitory), transaction number, purchase quantity (e.g., 2 sodas purchased in one transaction), and product(s) selected (e.g., Coca-Cola, Pepsi-Cola, Sprite, etc.), for example.

At step 120, the vending machine 4, via audit device 8, transfers the transaction record to the cashless payment provider 28, e.g., via transmitter 26 to receiver 32. Transaction records may be transferred as they are generated. Alternatively, the transaction records may be transferred in batches, e.g., nightly, weekly, upon request, etc.

At step 108, the transaction record is received at the cashless payment provider 47, e.g., via receiver 45. Further processing of the transaction record is described below with reference to step 112.

At step 122, an individual accesses the vending machine to perform a settlement event, which is described above with reference to FIG. 3. At optional step 127, the vending machine 4 authorizes access to the vending machine 4 by the individual. According to an exemplary embodiment, the audit device communicates with either the supplier 30 or the cashless payment provider 28, to confirm that the individual is authorized to perform the settlement event at a particular vending machine.

At step 123, the audit device 8 generates a settlement event indicator. The settlement event indicator is indicative of the settlement event and, in an exemplary embodiment, identifies when the settlement event occurred. The settlement event indicator is associated with data that may include, but is not limited to, the date of the settlement event, the time of the settlement event, an identifier for the vending machine, and a location of the vending machine.

At optional step 124, the individual is associated with the settlement event, e.g., by adding a unique code associated with the individual to the settlement event indicator. According to an exemplary embodiment, the processor 14 within the audit device 8 at the vending machine 4 receives the unique identifier from an identification card encoded with the unique number when the individual swipes the card through the cashless reader 12 to gain access to the vending machine at step 122. In another exemplary embodiment, the individual enters the unique code into a key pad (not shown) operably coupled to the audit device 8. Alternative methods for identifying the individual will be understood by one of skill in the art from the description herein.

At step 132, the audit device 8 transmits the settlement event indicator from the vending machine 4 to the cashless payment provider 28, e.g., via transmitter 26. In an exemplary embodiment, audit device 8 transmits the settlement event indicator via transmitter 26 to cashless payment provider 28 where it is received via receiver 32 in step 110. The settlement event indicator contains relevant data for the settlement event including, but not limited to, one or more of the date of the settlement event, the time of the settlement event, the vending machine identifier, the location of the vending machine, and the unique identifier of the individual performing the settlement event. The settlement event indicator may be transmitted to the cashless payment provider 28 when the settlement event occurs, on a periodic base, e.g., daily, or when requested by the cashless payment provider 47.

After the cashless payment provider 28 receives settlement event indicators for consecutive settlement events from the vending machine 4, in accordance with step 110, the cashless payment provider 28 is able to generate the electronic settlement value using process 107. In an exemplary embodiment, the process 107 of generating the electronic settlement value includes steps 108, 110, 112, 114 and 115.

At step 108, transaction records are received at the cashless payment provider 28 from the vending machine 4, via transmitter 66 of audit device 52. At step 110, settlement event indicators for consecutive settlement events are received at the cashless payment provider 28 from the vending machine 4 over a period of time. The transaction records may be received before, during and/or after the consecutive settlement events.

Once the consecutive settlement event indicators are received, the cashless payment provider 28 can identify the settlement period, i.e., the time span between a first settlement event indicator and a second settlement event indicator. The settlement period may be identified from the time values associated with each settlement event, for example. It should be understood that the electronic settlement value is calculated over the same period of time as the local settlement value, such that the electronic settlement value and the local settlement value may be correlated, compared and/or reconciled.

At step 112, the vending transactions recorded in the transaction records that occurred between the consecutive settlement events are identified. In an exemplary embodiment, a time value associated with each vending transaction is compared with the timestamps of the consecutive settlement event indicators to determine if it occurred within the settlement period in order to identify vending transactions that occurred between the consecutive settlement events.

At step 114, the cashless payment provider 28 calculates the electronic settlement value. In an exemplary embodiment, the cashless payment provider 28 calculates the electronic settlement value by summing the total value of all transaction records identified at step 112 as occurring within the settlement period (e.g., broken down into a cash value, a cashless value and a total value).

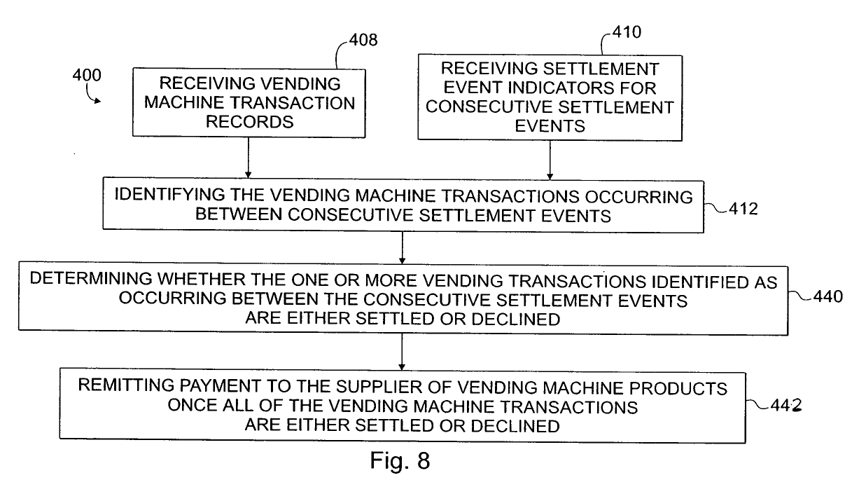

At step 115, the electronic settlement value is associated with an invoice number for accounting purposes. According to one exemplary embodiment, a unique invoice number is generated by accounts receivable 46 (or supplier 30) following each settlement event (or a predetermined interval). The invoice number is then transmitted to the cashless payment provider 28. The cashless payment provider 28 then associates the invoice number with the appropriate electronic settlement value prior to submitting that value to accounts receivable 46. By virtue of the unique invoice number, accounts receivable 46 may easily correlate an electronic settlement value with a settlement period payment (described with reference to FIG. 8) or a local settlement value, for example.

At step 116, the electronic settlement value and its associated invoice number are transmitted for reception by the supplier 30 (see step 104 of FIG. 2). In an exemplary embodiment, the processor 34 at the cashless payment provider 28 transmits the electronic settlement value to the supplier 30. Once received, the supplier 30 may combine the electronic settlement value with the value of the cash transactions recorded in the DEX file to properly account for the vending machine transactions that occurred during a settlement period and may optionally record it in an accounts receivable system 46.

In an alternative exemplary embodiment, the audit device 8 may generate and transfer the settlement value to the cashless payment provider 28 and/or supplier 30.

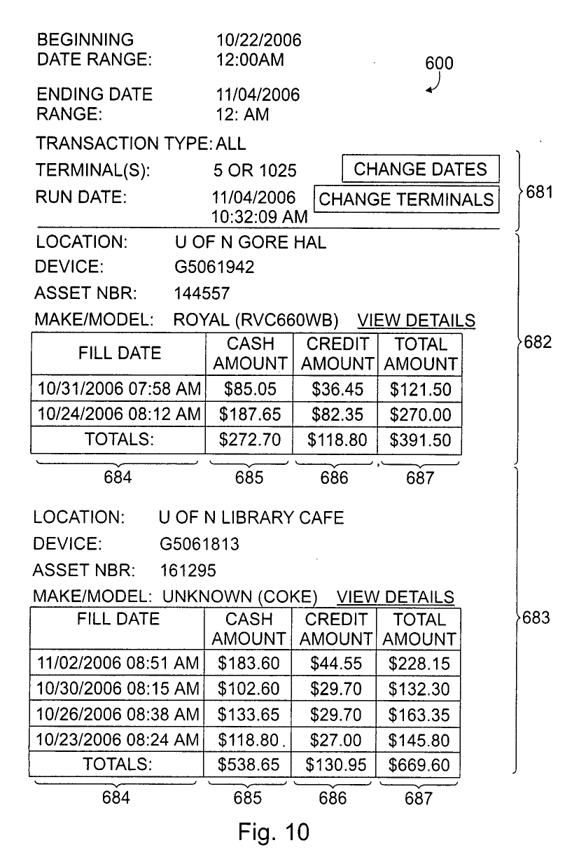

Referring back to FIG. 2, at step 106 the electronic settlement value is reconciled with the local settlement value. A local settlement value that is not equal to the electronic settlement value indicates that the individual (e.g., route driver) improperly entered the settlement value displayed on the vending machine at step 128 of FIG. 3. The step of reconciliation may include comparing the local settlement value to the electronic settlement value to determine if they are equal. Alternatively, the step of reconciliation may include posting the local and electronic settlement values to an accounts receivable system 46 for accounting purposes, as described below with reference to FIG. 5. The step of reconciliation may also include displaying the two settlement values on a web-based reporting system (described in greater detail below with reference to FIGS. 10-12).

FIG. 5 depicts a flow chart 200 of exemplary steps for reconciling vending machine transactions occurring between consecutive settlement events, according to another exemplary embodiment of the invention. The flow chart 200 is similar to flow chart 100, with the exception that the received local settlement value and the received electronic settlement value are posted to an accounts receivable system for processing at steps 236 and 238, respectively. Steps 102 and 104 are described above with reference to FIG. 2.

At step 206, the electronic settlement value is posted against, compared with, and/or reconciled with the local settlement value by the accounts receivable system 46. In an exemplary embodiment, the processor 42 compares the electronic settlement value and the local settlement value stored in memory 44, identifies discrepancies between the two values, and presents discrepancies to a user, e.g., via display device 43, such as a computer monitor or a printer. The reconciliation step 106 ensures accounting for all vending machine transactions and/or settlement values. By reconciling the electronic settlement value with the local settlement value, accounting inaccuracies due to imprecise entries by individuals (e.g., route drivers) can be avoided.

FIG. 6 depicts a flow chart 300 of exemplary steps for reconciling vending machine transactions occurring between consecutive settlement events, according to another exemplary embodiment of the invention. The flow chart 300 is similar to flow chart 100, with the exception that the electronic settlement value generated in step 304 is generated by the supplier, as opposed to the cashless payment provider in step 104. FIG. 6 corresponds with the block diagrams illustrated in FIGS. 1A and 1C.

At step 302, a local settlement value is obtained by the supplier 30. In an exemplary embodiment, step 302 of FIG. 6 is performed in the same manner as step 102 of FIG. 2. At step 304 an electronic settlement value is generated at the supplier 30, as described with reference to FIG. 7. At step 306, the electronic settlement value is compared with the local settlement value. In an exemplary embodiment, the processor 42 compares the electronic settlement value and the local settlement value stored in memory 44, identifies discrepancies between the two values, and presents discrepancies to a user, e.g., via an output device (not shown) such as a computer monitor or a printer. The electronic and local settlement values may be posted to an accounts receivable system 46 or a web-based reporting system (described below) for reconciliation.

FIG. 7 depicts a flow chart of exemplary steps for generating an electronic settlement value. According to this exemplary embodiment, the process 304 of generating an electronic settlement value is similar to the generating process 107 shown in FIG. 4, with the exception that steps 308, 310, 312 and 314 all occur at the supplier 30, as opposed to the cashless payment provider 28. In other words, unlike the process 107 shown in FIG. 4, the vending machine transaction records and the settlement event indicators are transmitted from the vending machine directly to the supplier 30. Additionally, there is no equivalent to transmitting step 116 in process 304, because the electronic settlement value is generated at the supplier 30.

FIG. 8 depicts a flow chart 400 of exemplary steps for remitting payment to a supplier of vending machine product (such as Coca-Cola or Pepsi-Cola for example) for cashless vending machine transactions occurring between consecutive settlement events. According to an exemplary embodiment, the steps of the flow chart 400 are performed by the cashless payment provider 28.

At step 408, transaction records are received. At step 410, the settlement event indicators for each of the consecutive settlement events are received. At step 412, the cashless transactions recorded in the transaction records that occurred between the consecutive settlement events are identified. Steps 408, 410, 412 may be performed in the same manner as steps 108, 110 and 112, respectively, that are shown in FIG. 4 and described previously.

At step 440, a determination is made regarding whether processing of the identified cashless vending transactions is complete. In an exemplary embodiment, processing of a cashless transaction is deemed complete once it is either settled or declined by a credit or account-issuing entity (e.g., Visa, MasterCard or a University). In accordance with this embodiment, once processing of the cashless vending transaction is complete the credit or account-issuing entity remits payment to the cashless payment provider 28 for the transactions settled.

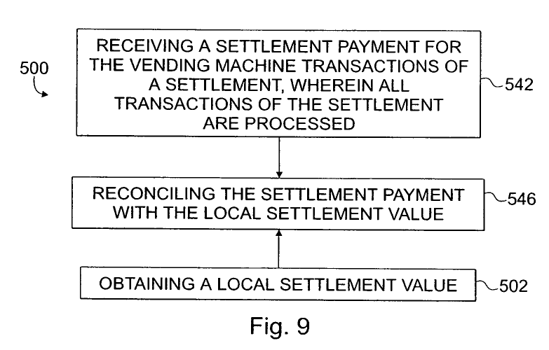

At step 442, payment is remitted to the supplier for the identified vending transactions occurring between the consecutive settlement events after processing of all of the identified vending transactions is complete. This process may be referred to in the art as a “settlement period payment,” “payment by settlement,” “settlement by fill,” or “payment by fill.” The settlement period payment may be remitted to the supplier in the form of an electronic funds transfer (EFT) payment. The settlement period payment may contain payment for one settlement period or multiple settlement periods. The EFT payment for each settlement period may be posted in an accounts receivable system 46, as discussed in greater detail with reference to FIG. 9.

For accounting purposes, suppliers may prefer to receive payment from third parties in one lump sum by settlement period once all of the cashless vending transactions in that settlement period have been fully processed, i.e., either settled or declined (i.e., payment by settlement). In an exemplary embodiment, if any cashless vending transaction in a settlement period has not been processed by the credit or account-issuing entity, payment for that entire settlement period is not remitted to the supplier. Alternatively, in a “payment by transaction” scenario, the cashless payment provider 28 remits payment to the supplier for all cashless vending transactions that have been processed by a particular point in time, e.g., on a weekly basis.

FIG. 9 depicts a flow chart 500 of exemplary steps for reconciling settlement period payments. At step 542, a settlement period payment is received at the supplier 30 for all of the processed cashless vending transactions for a particular settlement period. More specifically, the funds may be received at the supplier's bank, while the supporting detail of the settlement period payment (e.g., in report form) is received at the supplier 30. At step 502, the local settlement value is obtained by the supplier 30. Step 502 may be performed as previously described step 102 of FIG. 2. At step 546, the settlement period payment is reconciled with the local settlement value. The settlement period payment may be reconciled with the local settlement value in the supplier's accounts receivable system 46, e.g., to ensure the local settlement value is accurately reported by the individual (e.g., a route driver). Data from accounts receivable 46 may then be communicated back to the cashless payment provider 28 to report the status of the reconciliation, e.g., no discrepancy or a discrepancy between the local settlement value and settlement period payment. The settlement period payment may be associated with a particular invoice number (supplied by accounts receivable 46) for the purpose of correlation.

A world wide web (web) based reporting system is now described with reference to FIGS. 10-12B. The audit device 8 of the vending machine 4 (FIG. 1A) is configured to transmit settlement event indicators and transaction records to the supplier or the remote processing facility. In an exemplary embodiment, the data contained in each transaction record includes the vending machine identifier number, vending machine location (e.g., University Dormitory), transaction number, purchase price, purchase date, purchase time, purchase quantity (e.g., 2 sodas purchased in one transaction), product(s) selected (e.g., Coca-Cola, Pepsi-Cola, Sprite, etc.). In alternative exemplary embodiments some of this information may be omitted and/or other information may be added to the transaction records. In an exemplary embodiment, the data contained in each settlement event indicator includes the date of the settlement event, the time of the settlement event, the vending machine identifier number, the vending machine location (e.g., University Dormitory), and the unique identifier for the individual performing the settlement event. In alternative exemplary embodiments, some of this information may be omitted and/or additional information may be added to the settlement event indicator. The transaction records and settlement event indicator data in the web-based reporting system or other database system may be organized for monitoring, auditing, reconciliation and/or settlement operations.

The web-based reporting system may be hosted by the processor of the cashless payment provider, the supplier, or a known service provider, for hosting web-based reporting systems.

The web-based reporting system provides access to vending machine sales data for the purposes of monitoring, auditing, reconciliation and settlement operations. The web-based reporting system may additionally provide information for suppliers to conduct route settlement with full accountability for all transactions, both cash and cashless.

Users of the web-based reporting system may include suppliers, cashless payment providers, and/or other third parties.

Exemplary reports are depicted in FIGS. 10-12B. A user can configure a report with any number of fields, such as, vending machine identifier, vending machine location, payment type, payment amount, individual, route, settlement period, or settlement payment status, for example. The reports can provide sales by machine, location, route or total operation, and by settlement type, time-of-day and multiple machine reporting. Furthermore, reports can be used to help identify out-of-change conditions, low product inventory and out-of-service conditions. The reports are configurable to the needs of the particular user, and are not limited to the figures.

FIG. 10 depicts a simulated screenshot of an exemplary GUI 600 produced by the web-based reprinting system. GUI 600 is a report illustrating the total cash and cashless vending transactions recorded at two different vending machines for settlement periods ranging from Oct. 22, 2006 at 12:00 AM to Nov. 4, 2006 at 12:00 AM. Buttons 681 enable a user to modify the settlement period Date Range and the vending machines displayed in the report when selected, e.g., using a conventional selection device such as a computer mouse.

In FIG. 10 the total cash and cashless vending transactions recorded for two machines (device #'s G5061942 and G5061813) are displayed in tabular form. The transaction table for the first vending machine (device # G5061942) is identified by item 682, and the transaction table for the second vending machine (device # G5061813) is identified by item 683. In each transaction table, the settlement period ending date & time is displayed in column 684, the total cash amount transacted in a respective settlement period is displayed in column 685, the total cashless (i.e. credit) amount transacted in a respective settlement period is displayed in column 686, and the total combined cash and cashless amount transacted in a respective settlement period is displayed in column 687. The totals of columns 685, 686 and 687 are respectively listed in the bottom row of the transaction table. Additionally, the machine identifier number (e.g. G5061942), the asset number of the vending machine (e.g., 14457), the make and model of the vending machine, and the location of the vending machine are displayed above the transaction table.

The GUI 600 may be particularly useful for reconciling the ‘cash amount’ and the ‘credit amount’ figures in columns 685 and 686, respectively, with the cash collected from a vending machine and the sold product by settlement period. Furthermore, the ‘credit amount’ of column 686 may be correlated with the local settlement value for each settlement period. It should be understood that the ‘credit amount’ for each settlement period listed in column 686 corresponds to the electronic settlement value shown in the block diagram of FIG. 2.

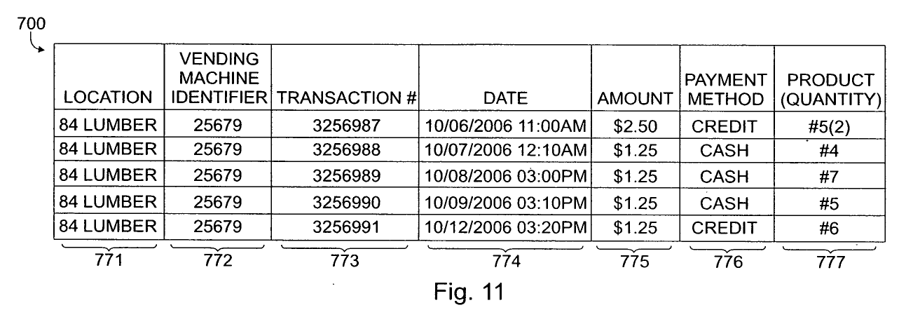

FIG. 11 depicts a simulated screen shot of another exemplary report 700. Report 700 is a report detailing the vending transactions occurring in a particular settlement period for a single vending machine. This report includes a transaction table listing the details of multiple transactions by settlement period in tabular form. The individual transactions that occurred within the settlement period are separated onto multiple rows of the transaction table. The start date and end date of the settlement period is listed above the transaction table. The physical location of a vending machine is displayed in column 771 of the transaction table, the vending machine identifier is displayed in column 772, the transaction number is displayed in column 773, the transaction date and time is listed in column 774, the transaction amount is listed in column 775, the payment method (i.e., cash or cashless) is listed in column 776, and the product selected and quantity purchased are listed in column 777.

Referring to the individual columns of report 700, the entries in columns 771 and 772 are the same, respectively, indicating that all transactions originated at a single vending machine (i.e., vending machine 25679 at the 84 Lumber location). The credit transaction identifiers are listed in column 773. Each transaction number listed in column 773 may be a selectable button (not shown) that reveals the status of the transaction (i.e., settled, declined or pending) when selected. The status of each transaction number may also be listed in a column of report 700. The price of each vending transaction is listed in column 775, which is useful for settlement period reconciliation purposes. In column 777, the product purchased is listed as a numerical value; for example, #5 may refer to Sprite and #7 may refer to Diet Coke. The inventory column 777 is useful for the purposes of tracking inventory and settlement period reconciliation. Because multiple products may be purchased in a single transaction, the quantity of the purchased products is also listed in column 777. For example, two purchases in a single transaction are shown in the top row of the transaction table.

FIGS. 12A and 12B depict exemplary reports 800 and 800′ detailing the financial data for multiple vending machines. The reports 800 and 800′ are useful for determining if payment should be remitted to the suppliers 30 for the cashless vending transactions that occurred during a settlement period. As described previously, suppliers 30 may prefer to receive payment by settlement period, i.e., in one lump sum, from the cashless payment providers 28 once all of the cashless vending transactions in that settlement period have been processed (i.e., settled or declined).

The payment status of the cashless transactions by settlement period for a particular vending machine is displayed in column 897 of report 800. In column 897, the term ‘Yes’ indicates that all of the cashless transactions in a settlement period for that vending machine are either settled or declined, and payment should be remitted to the supplier for those settled cashless transactions. Alternatively, the term ‘Waiting for Pending Transaction’ indicates that at least one cashless transaction in a settlement period has not been processed, and payment should be withheld. In FIG. 12B, the settlement period cashless transactions for each vending machine are ready for payment to the supplier 30, as indicated by the term ‘Yes’ in column 897. In FIG. 12A, only three vending machines have settlement period cashless transactions that are ready for payment to the supplier 30, as indicated in column 897.

The physical location of a vending machine is listed in column 871, the vending machine identifier number is listed in column 872, and the outlet number of the vending machine is listed in column 893. The vending machines may be listed in a searchable database, such that a user may select one or more of the vending machines from the searchable database for inclusion in report 800.

The total number of cashless transactions occurring in a settlement period for a particular vending machine is listed in column 890. The gross credit value for those completed cashless transactions is listed in column 891. The pending credit value is listed in column 892. The term ‘pending credit’ refers to instances where the credit or account-issuing entity 48 (e.g., Visa or MasterCard) has yet to process a vending transaction. In row 898, for example, a pending credit value of $1.25 remains because of one pending credit awaiting final processing. Accordingly, in column 897 of row 898, the payable status indicates ‘Waiting for Pending Transaction.’

The settled credit value is listed in column 894. Settled credit refers to the total value of the cashless transactions that have been processed and successfully approved. The settled credit value is equal to the gross credit value less the pending credit value and the value of the declined cashless transactions. Once no pending credits exist for a particular settlement period, the cashless payment provider 28 may remit payment to the supplier. The payment may be remitted in the form of an electronic funds transfer (EFT) payment, for example.

The settlement period start date and end date are listed in column 896. It should be understood that the settlement period start date corresponds to the date of a first settlement event identifier transmitted by the vending machine, and the settlement period end date corresponds to the date of the subsequent settlement event identifier transmitted by that vending machine. It should also be understood that the settlement period end date is the settlement period start date for a subsequent settlement period (not shown).

The web-based reporting system may be implemented in computer software that may be run on a general purpose computer. The software may reside on a computer readable carrier such as a magnetic or semiconductor memory device, a magnetic or optical disc or a radio-frequency, audio-frequency or optical carrier wave.

Utilizing the web-based reporting system, users of the reporting system are able to construct customized reports for tracking vending machine sales data. According to one aspect of the invention, a report is a configurable record of vending machine sales data presented in a web-based graphical user interface (GUI) format for display on a user's computer, over an Intranet, or the Internet, for example.

By way of non-limiting example, vending machines operable with the processes disclosed herein can include beverage style vending machines, snack style vending machines, specialty style vending machines, copiers, fax machines, automated kiosks (as described in greater detail later), laundry machines, parking machines, personal computers (PC), data ports, office equipment, and or other types of vending, retail, office products, or business center types of equipment. Specialty style vending machines include, for example and not limitation, ice cream vending machines, amusement and arcade games, amusement ride game commonly found in store fronts and shopping malls, fresh produce machines, french fry vending machines, novelty product vending machines, consumer goods style vending machines, and or services type vending machine (such as name tag making, card making, polishing machines, and other service types of vending machines). Other vending machine applications not explicitly listed above, will be understood to those skilled in the art from the description herein.

A variety of cashless payment devices may be used for cashless vending transactions, including credit cards, debit cards, prepayment cards, smart cards, employee ID cards, student ID cards, hotel room keys, e-gift cards, RFID (radio frequency identification) devices, cellular phones, and a variety of specialty account cards (e.g. corporate program cards and loyalty program cards).

The methods of reconciling cashless transactions described herein present an improvement over existing processes for reconciling cashless transactions. The importance of accurately reconciling cashless transactions has come to light as the number of vending machine having cashless terminals (i.e., debit/credit cashless readers) has steadily increased. As recognized in the National Automatic Merchandising Association (NAMA) commissioned study of Cashless Vending by Michael Kasavana, the movement from physical currency to cashless payments is becoming more prevalent as advancements in automated banking, account management, and innovative reconciliation systems gain in popularity.

Suppliers have attempted to address the reconciliation problem with limited success. In one method of reconciliation, suppliers undergo the reconciliation process after each settlement event of a vending machine. During the settlement event the individual collects the cash, uploads the DEX file (containing cash transactions) onto his or her portable computer 21, and records the total value of the cashless transactions (transacted since the last settlement event) displayed on the vending machine. The DEX file and the cashless transaction total are then reconciled with the cash collected and the goods sold. If the individual recorded the cash and cashless transaction total inaccurately, the DEX file cannot be accurately reconciled with the cash collected and cashless payments paid by cashless payment provider 28 and the goods sold. Thus, this method of reconciliation presents an opportunity for inaccuracy, and even theft. While the supplier could conceivable wait to receive a report of the settled cashless transactions from the various credit or account-issuing entities (such as a bank, Visa or MasterCard), it would be time consuming to manually correlate each cashless transaction with a particular settlement event of a vending machine. The present invention solves this problem.

The systems and processes disclosed herein are not limited to vending machines having cashless readers. The systems and processes disclosed herein may also be relevant for kiosks, laundry, parking, and any other service that incorporates cashless transactions. The benefit of the invention disclosed herein may be recognized for any system having an accounting and sales cycle (e.g., revenue recognition, accounts receivable, cash collection, inventory, etc.) that is based on a definable event such as a settlement event, restocking event, cash collection, or a downloading event, for example.

For example, the systems and processes disclosed herein are relevant for a digital music kiosk where consumers purchase digital music to create a customizable compact disc (CD) or download onto their portable digital music player, such as an ipod®. In this example, consumers may pay a fee to download the music at the music kiosk using either cash or cashless means. At a settlement event, an individual (e.g., route driver) may perform the following steps, for example, collect the cash stored in the kiosk, locally record a settlement value onto a handheld computer, and refill the music kiosk with blank CD's. The settlement value may be displayed on a user display of the kiosk, for example. Following the settlement event, the kiosk transmits an electronic settlement value to the supplier (or cashless payment provider), via wired or wireless means. The supplier may then reconcile the electronic settlement value with the local settlement value. The above system and process is also relevant for a digital photo kiosk where consumers develop digital photos stored on their digital cameras, CD's, etc.

The systems and processes disclosed herein are also relevant for an automated laundry system that accepts cash and cashless payment. Consumers utilize automated laundry systems to operate a clothes washer, a clothes dryer, or purchase laundry detergent or fabric softener, for example. At a settlement event, an individual may perform one or more of the following steps, for example, collect the cash stored in the laundry system, locally record a settlement value onto a handheld computer, and refill the laundry system with laundry detergent or fabric softener. Following the settlement event, the laundry system transmits an electronic settlement value to the supplier, via wired or wireless means. The supplier may then reconcile the electronic settlement value with the local settlement value.

The systems and processes disclosed herein are also relevant for automated parking systems. In this example, consumers may deposit cash or swipe a credit or debit card into an automated parking machine. Upon receiving payment, the parking machine may either open a gate to permit the consumer to park, or provide the consumer with a parking voucher, for example. At a settlement event, an individual (e.g., route driver) may perform one or more of the following steps, for example, collect the cash stored in the parking machine, locally record a settlement value onto a handheld computer, and optionally refill the parking machine with parking vouchers. Following the settlement event, the parking system transmits an electronic settlement value to the supplier, via wired or wireless means. The supplier may then reconcile the electronic settlement value with the local settlement value.

While exemplary embodiments of the invention have been shown and described herein, it will be understood that such embodiments are provided by way of example only. Examples provided may describe the invention in terms of processes performed for vending machines, however, the application for these processes span all industries. Numerous variations, changes and substitutions will occur to those skilled in the art without departing from the spirit of the invention.

What is claimed:

1. A method of reconciling vending machine transactions occurring between consecutive settlement events, the method comprising the steps of:
obtaining a local settlement value at a processing facility, the local settlement value being the total value of all vending transactions that occurred at the vending machine between the consecutive settlement events;
receiving an electronic settlement value at the processing facility, the electronic settlement value being the total value of all vending transactions that occurred at the vending machine between the consecutive settlement events; and
reconciling the local settlement value with the electronic settlement value.

2. The method of claim 1, wherein the vending transactions are all cashless transactions occurring at the vending machine between consecutive settlement events.

3. The method of claim 2, wherein the cashless transactions include credit and/or debit transactions.

4. The method of claim 1, wherein the vending transactions are cash and/or cashless transactions occurring at the vending machine between consecutive settlement events.

5. The method of claim 1, wherein the vending transactions are all cash transactions occurring at the vending machine between consecutive settlement events.

6. The method of claim 1, further comprising the step of generating the electronic settlement value, the generating step occurring prior to the step of receiving the electronic settlement value.

7. The method of claim 6, wherein the step of generating the electronic settlement value comprises the steps of:
receiving settlement event indicators identifying the consecutive settlement events from the vending machine;
receiving vending machine transaction records from the vending machine;
identifying the vending transactions that occurred between the consecutive settlement events from the vending machine transaction records; and
calculating the electronic settlement value from the identified vending transactions that occurred between the consecutive settlement events.

8. The method of claim 7, further comprising the step of transmitting the electronic settlement value to the processing facility.

9. The method of claim 7, further comprising the step of authorizing an individual to settle the vending machine, and each settlement event indicator further identifying the authorized individual.

10. The method of claim 1, wherein the obtaining step comprises the steps of generating the local settlement value at the vending machine, locally recording the local settlement value, and receiving the locally recorded settlement value at the processing facility.

11. The method of claim 10, wherein the generating step further comprises displaying the local settlement value on a display of the vending machine.

12. The method of claim 11, wherein the locally recording step further comprises manually recording the displayed local settlement value displayed on the vending machine.

13. The method of claim 11, wherein the locally recording step further comprises communicating the local settlement value displayed on the vending machine to a portable electronic device.

14. The method of claim 13, further comprising the step of transmitting the local settlement value from the portable electronic device to the processing facility.

15. The method of claim 1, wherein the step of obtaining the local settlement value comprises the steps of receiving locally recorded sales data and calculating the locally recorded settlement value from the locally recorded sales data.

16. The method of claim 1, wherein the electronic settlement value further includes the purchase price, purchase type, purchase time, purchase date, and purchase selection for the transactions.

17. A computer-readable carrier including computer program instructions that cause a general purpose computer to perform the method of claim 1.

18. The method of claim 1, further comprising the step of posting the local settlement value and the electronic settlement value into an accounts receivable system.

19. The method of claim 18, further comprising the step of comparing the local settlement value to the electronic settlement value at the accounts receivable system.

20. A computer-readable carrier including computer program instructions that cause a general purpose computer to perform the posting step of claim 19.

21. A method of reconciling vending machine transactions occurring between consecutive settlement events, the method comprising the steps of:
obtaining a local settlement value, the local settlement value being the total value of all vending machine transactions that occurred at the vending machine between the consecutive settlement events;
generating an electronic settlement value, the electronic settlement value being the total value of all vending machine transactions that occurred at the vending machine between the consecutive settlement events; and
comparing the electronic settlement value with the local settlement value.

22. The method of claim 21, wherein the step of generating the electronic settlement value comprises the steps of:
receiving settlement event indicators identifying the consecutive settlement events from the vending machine;
receiving vending machine transaction records from the vending machine;
identifying the vending machine transactions that occurred between the consecutive settlement events from the vending machine transaction records; and
calculating the total value of the vending machine transactions that occurred at the vending machine between the consecutive settlement events to generate the electronic settlement value.

23. The method of claim 22, further comprising the step of authorizing an individual to settle the vending machine, wherein each settlement event indicator further identifies the authorized individual.

24. The method of claim 21, wherein the vending transactions are all cashless transactions occurring at the vending machine between consecutive settlement events.

25. The method of claim 24, wherein the cashless transactions include credit and/or debit transactions.

26. The method of claim 21, wherein the vending machine transactions are cash and/or cashless transactions occurring at the vending machine between consecutive settlement events.

27. The method of claim 21, wherein the vending machine transactions are all cash transactions occurring at the vending machine between consecutive settlement events.

28. The method of claim 21, wherein each vending machine transaction record includes the purchase price, purchase type, purchase time, purchase date, and purchase selection of the transaction.

29. A computer-readable carrier including computer program instructions that cause a general purpose computer to perform the method of claim 21.

30. The method of claim 21, further comprising the step of posting the local settlement value and the electronic settlement value into an accounts receivable system.

31. The method of claim 21, wherein the step of obtaining the local settlement value comprises the steps of receiving locally recorded sales data and calculating the locally recorded settlement value from the locally recorded sales data.

32. A method for paying a supplier of vending machine goods for vending machine transactions occurring between consecutive settlement events, the method comprising the steps of:
receiving settlement event indicators identifying the consecutive settlement events;
receiving vending machine transaction records;
identifying the vending transactions occurring between the consecutive settlement events from the vending machine transaction records;
processing the vending transactions identified as occurring between the consecutive settlement events; and
remitting payment to the supplier for the identified vending transactions occurring between consecutive settlement events after processing of all of the identified vending transactions occurring between consecutive settlement events is complete.

33. The method of claim 32, wherein the vending machine transactions are all cashless transactions occurring at the vending machine between consecutive settlement events.

34. The method of claim 33, wherein the cashless transactions include credit and/or debit transactions.

35. The method of claim 32, wherein the vending machine transactions are cash and/or cashless transactions occurring at the vending machine between consecutive settlement events.

36. The method of claim 32, wherein the vending machine transactions are all cash transactions occurring at the vending machine between consecutive settlement events.

37. A computer-readable carrier including computer program instructions that cause a general purpose computer to perform the method of claim 32.

38. The method of claim 32, wherein the processing step includes determining whether the identified vending transactions are either settled or declined.

39. The method of claim 32, wherein a settlement period comprises the identified vending transactions occurring between two consecutive settlement events, and payment to the supplier includes multiple settlement periods.

40. A method of generating an electronic settlement value for vending machine transactions occurring between consecutive settlement events, the method comprising the steps of:
receiving settlement event indicators identifying the consecutive settlement events from a vending machine;
receiving vending machine transaction records from the vending machine;
identifying the vending machine transactions that occurred between the consecutive settlement events from the vending machine transaction records; and
calculating the total value of the vending machine transactions that occurred at the vending machine between the consecutive settlement events to generate the electronic settlement value.

41. The method of claim 40, further comprising the step of authorizing an individual to settle the vending machine, wherein each settlement event indicator further identifies the authorized individual.
